(19) United States
(12) Patent Application Publication
(10) Pub. No.: US 2026/0266353 A1
(43) Pub. Date: Sep. 10, 2026

(54) DAMPER DEVICE

(71) Applicant: AISIN CORPORATION, Kariya, Aichi (JP)

(72) Inventors: Tomoki KOUROKI, Kariya-shi, Aichi-ken (JP); Masanori SUZUKI, Kariya-shi, Aichi-ken (JP); Daisuke HAYASHI, Kariya-shi, Aichi-ken (JP); Masami OKUMARU, Kariya-shi, Aichi-ken (JP); Kosuke KONDO, Kariya-shi, Aichi-ken (JP)

(73) Assignee: AISIN CORPORATION, Kariya, Aichi (JP)

(21) Appl. No.: 18/876,339

(22) PCT Filed: Sep. 6, 2023
(86) PCT No.: PCT/JP2023/032549

§ 371 Date: Dec. 18, 2024

(30) Foreign Application Priority Data
Sep. 27, 2022 (JP) 2022-154059

(51) Int. Cl. F16D 3/12; F16D 3/66

(52) U.S. Cl. CPC F16F 15/1217; F16F 15/1234

(57) ABSTRACT

Provided is a damper device including: a first rotation body including: a first plate that rotates about a rotation axis; a second plate that rotates integrally with the first plate; and a second rotation body that rotates relative to the first rotation body about the rotation axis via an elastic mechanism disposed between the first and second rotation bodies. The first plate includes a drawn portion recessed in a direction from a main surface of the first plate toward the second plate, and the second plate includes a drawn portion that is recessed from a main surface of the second plate toward the first drawn portion and fixed to the first drawn portion. One of the drawn portions comes into contact with the engagement portion of the second rotation body relatively rotating with respect to the first rotation body to restricts rotation of the second rotation body.

### CROSS REFERENCE TO RELATED APPLICATIONS

This application is a National Stage of International Application No. PCT/JP 2023/032549 filed Sep. 6, 2023, claiming priority based on Japanese Patent Application No. 2022-154059 filed Sep. 27, 2022, the entire contents of which are incorporated in their entirety.

### TECHNICAL FIELD

The technique disclosed in the present application relates to a damper device.

### BACKGROUND ART

In a vehicle or the like, a damper device that absorbs a fluctuation of torque transmitted from a drive source such as an engine toward a transmission is provided on a torque transmission path between the drive source and the transmission.

As an example of such a damper device, a damper device disclosed in Patent Literature 1 (JP 2021 028520 A) is known. The damper device disclosed in Patent Literature 1 includes: a lining plate (reference sign 100 in Patent Literature 1) to which power is transmitted from a flywheel; a disc plate (reference sign 200 in Patent Literature 1) including (i) a first plate (reference sign 201 in Patent Literature 1) to which power is transmitted from the lining plate and that rotates about a rotation axis and (ii) a second plate (reference sign 202 in Patent Literature 1) that is disposed to face the first plate and rotates integrally with the first plate; and a hub (reference sign 300 in Patent Literature 1) that is elastically connected to the disc plate with an elastic mechanism part (reference sign 400 in Patent Literature 1) interposed therebetween and rotates relatively to the disc plate.

In the damper device disclosed in Patent Literature 1, projections (reference sign 306 in Patent Literature 1) provided on an outer peripheral edge of the hub come into contact with restriction portions (reference sign 210 in Patent Literature 1) that are outer edge of notches provided in the first plate and are formed by bending this plate, thereby functioning as a stopper to restrict relative rotation of the hub with respect to the disc plate by a predetermined angle or more (see FIG. 4 in Patent Literature 1). Note that the entire contents of Patent Literature 1 are incorporated herein by reference.

As another example of the damper device, a damper device disclosed in Patent Literature 2 (WO 2007/124709 A) is known. The damper device disclosed in Patent Literature 2 includes: a drive disc (reference sign 2 in Patent Literature 2) to which power is transmitted from an engine; a flange part (reference sign 15 in Patent Literature 2) coupled to the drive disc via springs; and a hub part (reference sign 16 in Patent Literature 2) fixed to the flange part.

In the damper device disclosed in Patent Literature 2, the flange part fixed to the hub part comes into contact with rivets (reference signs 23, 24, and so on in Patent Literature 2) fixed to the drive disc, so that the rivets function as a stopper for restricting the relative rotation of the hub part with respect to the drive disc by a predetermined angle or more (see FIG. 1 of Patent Literature 2). Note that the entire contents of Patent Literature 2 are incorporated herein by reference.

### CITATIONS LIST

### Patent Literature

Patent Literature 1: JP 2021-028520 A

Patent Literature 2: WO 2007/124709 A

### SUMMARY OF THE DISCLOSURE

### Technical Problems

However, in the damper device disclosed in Patent Literature 1, since the restriction portions are formed by bending the first plate, the sizes of portions that are parts of the restriction portions and come into contact with the projections of the hub cannot be made larger than a plate thickness of the first plate. Therefore, pressures (surface pressure) applied by the projections of the hub to the parts, of the restriction portions, in contact with the projections of the hub increase, and stress locally concentrates. Therefore, it is considered that some measures need to be performed to reinforce strength of the restriction portions.

On the other hand, in the damper device disclosed in Patent Literature 2, since the flange part repeatedly comes into contact with the rivets fixed to the drive disc, that is, torque is repeatedly input, so that the rivets, which need to be formed of a soft material, are loosened or deformed with respect to the drive disc. As a result, there is a problem that the rivets lose the function as the stopper.

Therefore, the technique disclosed in the present application provides a damper device including a stopper having improved performance.

### Solutions to Problems

A damper device according to one aspect can adopt the following configuration. “A configuration including: a first rotation body, the first rotation body including: a first plate to which power is transmitted from a flywheel and that rotates about a rotation axis; a second plate that is disposed to face the first plate at a distance from the first plate and rotates integrally with the first plate about the rotation axis; and a second rotation body that rotates relative to the first rotation body about the rotation axis while expanding or contracting an elastic mechanism part disposed along a circumferential direction between the second rotation body and the first rotation body, the second rotation body including an engagement portion protruding radially outward at an outer peripheral edge of the second rotation body. The first plate includes a first drawn portion recessed in a direction from a first main surface of the first plate toward the second plate, and the second plate includes a second drawn portion that is provided to face the first drawn portion, is recessed in a direction from a second main surface of the second plate toward the first drawn portion, and is fixed to the first drawn portion by using a fastening member, and the first drawn portion and the second drawn portion come into contact with the engagement portion of the second rotation body in a state of relatively rotating with respect to the first rotation body, and restrict further rotation of the second rotation body in a direction in which the elastic mechanism part is contracted.”

The technique disclosed in the present application can provide a damper device including a stopper having improved performance.

### BRIEF DESCRIPTION OF DRAWINGS

FIG. 1 is a perspective view schematically illustrating an example of a configuration of a damper device according to one embodiment.

FIG. 2 is a top view schematically illustrating the configuration of the damper device illustrated in FIG. 1.

FIG. 3 is a perspective view schematically illustrating a partial configuration of the damper device illustrated in FIG. 1.

FIG. 4 is a top view schematically illustrating the configuration of the damper device illustrated in FIG. 3.

FIG. 5 is an enlarged perspective view schematically illustrating a partial configuration of the damper device illustrated in FIG. 3 as viewed from a viewpoint different from that of FIG. 3.

FIG. 6 is an enlarged perspective view schematically illustrating a partial configuration of the damper device illustrated in FIG. 1 as viewed from a viewpoint different from that of FIG. 1.

FIG. 7A is an enlarged perspective view schematically illustrating a partial configuration of the damper device illustrated in FIG. 3 in which ribs are provided on first drawn portions 120.

FIG. 7B is a diagram schematically illustrating distribution of stress applied to the first drawn portion 120 and a periphery thereof when engagement portions 208 of a hub 200 come into contact with the first drawn portions 120 in the damper device illustrated in FIG. 7A.

FIG. 7C is a view schematically illustrating a displacement amount in an axial direction generated between a first disc plate 100A and a second disc plate B when the engagement portions 208 of the hub 200 come into contact with the corresponding first drawn portions and second drawn portions in the damper device including (i) the first drawn portions 120 each including, at both ends thereof, the first rib illustrated in FIG. 7A and (ii) the second drawn portions 150 illustrated in FIG. 2.

FIG. 8A is an enlarged perspective view schematically illustrating, as a comparative example with respect to the damper device illustrated in FIG. 7A, a partial configuration of the damper device illustrated in FIGS. 1 to 6.

FIG. 8B is a diagram schematically illustrating distribution of stress applied to the first drawn portion 120 and the periphery thereof when the engagement portions 208 of the hub 200 come into contact with the first drawn portions 120 in the damper device illustrated in FIG. 8A.

FIG. 8C is a view schematically illustrating a displacement amount in the axial direction generated between the first disc plate 100A and the second disc plate B when the engagement portions 208 of the hub 200 come into contact with the corresponding first drawn portions and second drawn portions in the damper device illustrated in FIGS. 1 to 6.

FIG. 9 is a perspective view schematically illustrating a configuration of another hub used in the damper device illustrated in FIG. 1.

FIG. 10 is a top view schematically illustrating the configuration of the hub illustrated in FIG. 9.

### DESCRIPTION OF EMBODIMENTS

Hereinafter, various embodiments will be described with reference to the accompanying drawings. Note that, components common in the drawings are denoted by the same reference signs. In addition, it should be noted that the components illustrated in a certain drawing may be omitted in another drawing for convenience of description. Furthermore, it should be noted that the accompanying drawings are not necessarily drawn to scale.

### 1. Configuration of Damper Device

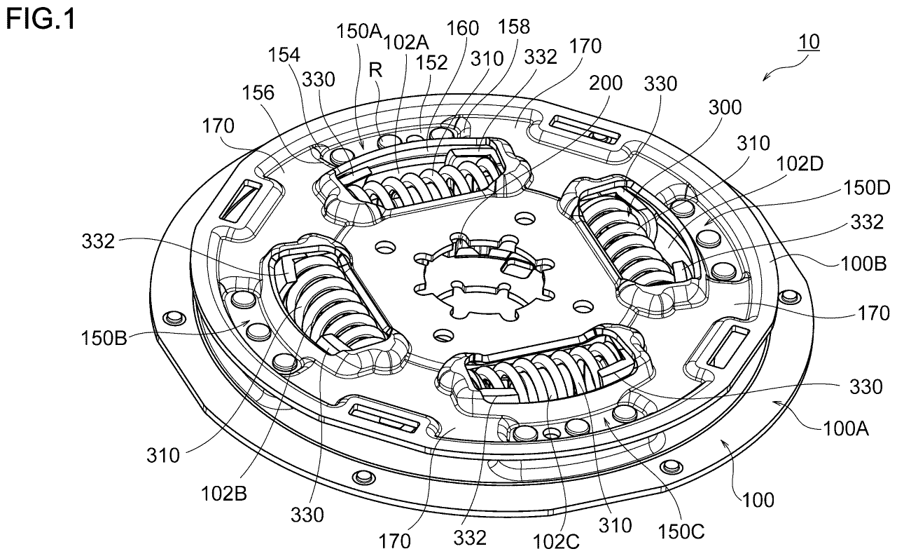

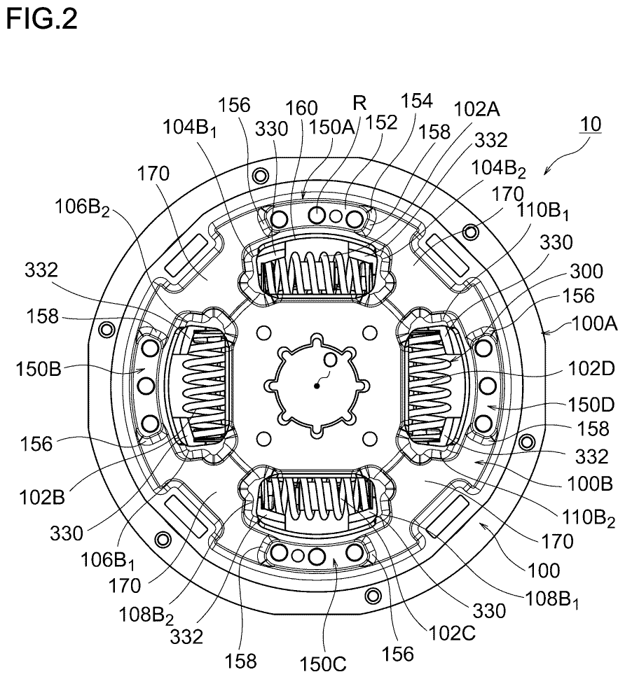

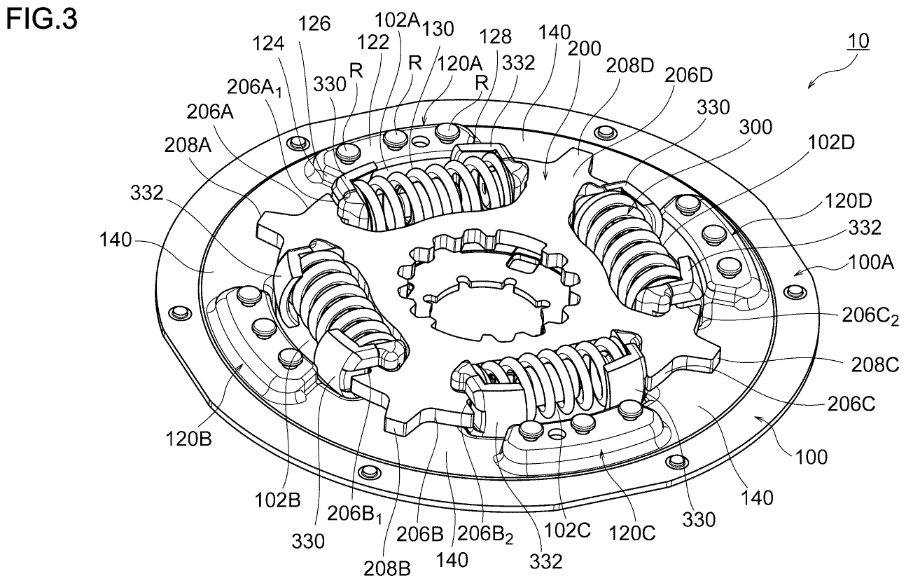

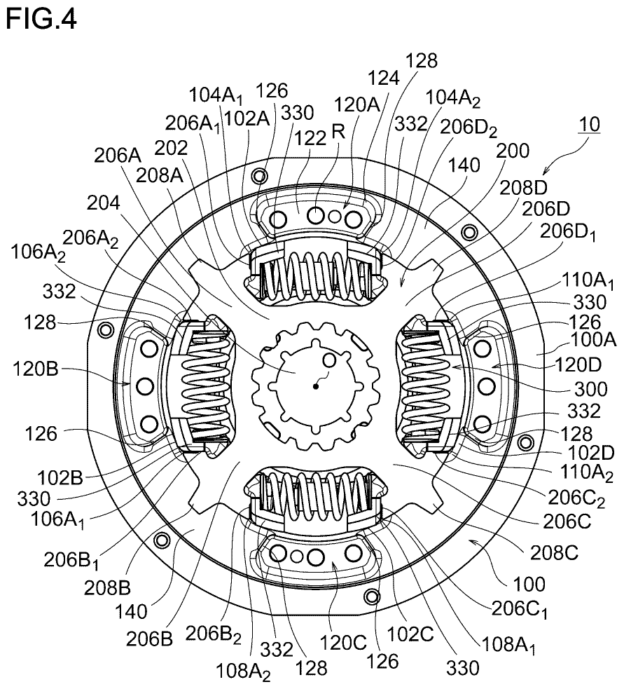

With reference to FIGS. 1 to 4, an outline of a configuration of a damper device according to one embodiment will be described. FIG. 1 is a perspective view schematically illustrating an example of a configuration of a damper device according to one embodiment. FIG. 2 is a top view schematically illustrating the configuration of the damper device illustrated in FIG. 1. FIG. 3 is a perspective view schematically illustrating a partial configuration of the damper device illustrated in FIG. 1. FIG. 4 is a top view schematically illustrating the configuration of the damper device illustrated in FIG. 3.

Note that FIG. 3 illustrates the damper device in a state where a second disc plate 100B of a disc plate 100 to be described later is removed from FIG. 1, and, similarly, FIG. 4 illustrates the damper device in a state where the second disc plate 100B to be described later is removed from FIG. 2.

A damper device 10 according to one embodiment is pressed between, for example, a flywheel (not illustrated) and a pressure plate (not illustrated), so that driving force from a drive source such as an engine or a motor can be transmitted to a transmission. Since a structure for clamping the damper device 10 between the flywheel and the pressure plate is well known, a detailed description thereof will be omitted.

The damper device 10 can absorb and attenuate vibration in a twisting direction. As illustrated in FIGS. 1 to 4, the damper device 10 can include: the disc plate 100 as a first rotation body to which power is transmitted from a flywheel (not illustrated) directly or indirectly via another member; a hub 200 as a second rotation body coupled to an input shaft of a transmission (not illustrated); and at least one elastic mechanism part 300 disposed, between the disc plate 100 and the hub 200, to extend along a circumferential direction.

### 1-1. Hub 200

The hub 200 may be disposed on an output side in a power transmission path.

The hub 200 can be formed of, for example, a metal material, have a shape extending in a substantially annular shape as a whole, and be provided rotatably about a rotation axis O. As best illustrated in FIG. 4, the hub 200 can be spline-coupled to an input shaft (not shown) of a transmission (not shown) by inserting the input shaft into a through hole 204 formed in a substantially annular cylindrical portion 202.

The hub 200 can also include a plurality of flanges 206 extending radially from the cylindrical portion 202. In one example, as described below, corresponding to a configuration in which the disc plate 100 includes four accommodation regions 102 (102A, 102B, 102C, and 102D), the hub 200 can include a total of four flanges 206 (206A, 206B, 206C, and 206D) so that a total of two flanges 206 are located at both ends of each accommodation region 102.

When focusing on the accommodation region 102A of the disc plate 100, as illustrated in FIG. 4, a notch 206A₁ can be formed on one side of the flange 206A (on the right side with the flange 206A located at the center, on the paper surface). The notch 206A₁ can support, from the circumferential outside, a first sheet member 330 of the elastic mechanism part 300 accommodated in the accommodation region 102A.

On the other hand, a notch 206D₂ can be formed on the other side of the flange 206D (on the left side with the flange 206D located at the center, on the paper surface). The notch 206D₂ can support, from the circumferential outside, a second sheet member 332 of the elastic mechanism part 300 accommodated in the accommodation region 102A.

When focusing on the accommodation region 102B of the disc plate 100, as illustrated in FIG. 4, a notch 206B₁ can be formed on one side of the flange 206B (the upper side with the flange 206B located at the center, on the paper surface). The notch 206B₁ can support, from the circumferential outside, a first sheet member 330 of the elastic mechanism part 300 accommodated in the accommodation region 102B.

On the other hand, a notch 206A₂ can be formed on the other side of the flange 206A (on the left side with the flange 206A located at the center, on the paper surface). The notch 206A₂ can support, from the circumferential outside, a second sheet member 332 of the elastic mechanism part 300 accommodated in the accommodation region 102B.

When focusing on the accommodation region 102C of the disc plate 100, as illustrated in FIG. 4, a notch 206C₁ can be formed on one side of the flange 206C (the lower side with the flange 206C located at the center, on the paper surface). The notch 206C₁ can support the first sheet member 330 of the elastic mechanism part 300 accommodated in the accommodation region 102C from the circumferential outside.

On the other hand, a notch 206B₂ can be formed on the other side of the flange 206B (on the lower side with the flange 206B located at the center, on the paper surface). The notch 206B₂ can support the second sheet member 332 of the elastic mechanism part 300 accommodated in the accommodation region 102C from the circumferential outside.

When focusing on the accommodation region 102D of the disc plate 100, as illustrated in FIG. 4, a notch 206D₁ can be formed on one side of the flange 206D (on the right side with the flange 206D located at the center, on the paper surface). The notch 206D₁ can support, from the circumferential outside, a first sheet member 330 of the elastic mechanism part 300 accommodated in the accommodation region 102D.

On the other hand, a notch 206C₂ can be formed on the other side of the flange 206C (on the upper side with the flange 206C located at the center, on the paper surface). The notch 206C₂ can support the second sheet member 332 of the elastic mechanism part 300 accommodated in the accommodation region 102D from the circumferential outside.

Furthermore, the hub 200 can include an engagement portion 208 protruding radially outward at an outer peripheral edge of at least one of the flanges 206A to 206D. FIG. 4 illustrates an example in which the hub 200 includes the engagement portions 208A to 208D at the respective outer peripheral edges of the flanges 206A to 206D.

The engagement portions 208 can have any shape as long as the engagement portions 208 have a shape protruding radially outward from the outer peripheral edges of the flanges 206. For example, as exemplified in FIG. 4, each engagement portion 208 can have a substantially trapezoidal shape in top view. In another example, each engagement portion 208 can have a rectangular shape, a circular shape, and/or a shape in which these shapes are combination. Furthermore, in a case where a plurality of engagement portions 208 are provided, the plurality of engagement portions 208 can have mutually substantially the same shape or can have shapes different from each other.

### 1-2. Disc Plate 100

### (1) Basic Configuration

The disc plate 100 may be disposed on an input side on the power transmission path. The disc plate 100 can be formed of, for example, a metal material.

As illustrated in FIGS. 1 and 2, the disc plate 100 can include a first disc plate 100A and a second disc plate 100B as a pair of members provided on axially both sides of the hub 200 in the axial direction. Each of the first disc plate 100A and the second disc plate 100B can have a substantially annular shape as a whole. The first disc plate 100A and the second disc plate 100B are disposed at a distance from each other, and can be provided rotatably with respect to the hub 200 about the central axis O with the hub 200 and the elastic mechanism part 300 interposed therebetween. The first disc plate 100A can be coupled directly to a flywheel (not illustrated) or to a lining plate fixed to a flywheel (not illustrated) via a friction material or the like. With this arrangement, power is transmitted from the flywheel to the first disc plate 100A and the second disc plate 100B coupled to the first disc plate 100A, and the disc plates can rotate about the rotation axis O.

The first disc plate 100A and the second disc plate 100B can cooperate with each other to form at least one accommodation region 102, here, as an example, four accommodation regions 102A, 102B, 102C, and 102D. Each of the accommodation regions 102 can partially accommodate a set of elastic mechanism part 300 (the set of elastic mechanism parts 300 can be partially expose to the outside). In order to form such an accommodation regions 102, as illustrated in FIGS. 1 to 4, the first disc plate 100A and the second disc plate 100B can each include opening portions at portions respectively corresponding to the accommodation regions.

The disc plate 100 can accommodate the elastic mechanism parts 300 in the respective accommodation regions 102. Specifically, as illustrated in FIGS. 1 to 4, the disc plate 100 can accommodate, in the accommodation region 102A, a set of elastic mechanism part 300, that is: an elastic body (elastic member) 310; and the first sheet member 330 and the second sheet member 332 disposed on both sides of the elastic body 310.

Similarly, the disc plate 100 can accommodate, also in each of the accommodation regions 102B, 102C, and 102D, the above-described set of elastic mechanism part 300 (elastic body 310, first sheet member 330, and second sheet member 332).

Furthermore, the disc plate 100 can support two sheets included in the elastic mechanism part 300 accommodated in each accommodation region 102. First, focusing on the accommodation region 102A. As illustrated in FIG. 4, a first end surface 104A₁ surrounding one end of the accommodation region 102A (opening portion) in the first disc plate 100A can support the first sheet member 330 by being in contact with the first sheet member 330 from the circumferential outside. Similarly, as illustrated in FIG. 2, a first end surface 104B₁ surrounding one end of the accommodation region 102A (opening portion) in the second disc plate 100B can support the first sheet member 330 by being in contact with the first sheet member 330 from the circumferential outside.

Furthermore, a second end surface 104A₂ surrounding the other end of the accommodation region 102A (opening portion) in the first disc plate 100A can support the second sheet member 332 by being in contact with the second sheet member 332 from the circumferential outside. Similarly, as illustrated in FIG. 2, a second end surface 104B₂ surrounding the other end of the accommodation region 102A (opening portion) in the second disc plate 100B can support the second sheet member 332 by being in contact with the second sheet member 332 from the circumferential outside.

Next, focusing on the accommodation region 102B. As illustrated in FIG. 4, a first end surface 106A₁ surrounding one end of the accommodation region 102B (opening portion) in the first disc plate 100A can support the first sheet member 330 by being in contact with the first sheet member 330 from the circumferential outside.

Similarly, as illustrated in FIG. 2, a first end surface 106B₁ surrounding one end of the accommodation region 102B (opening portion) in the second disc plate 100B can support the first sheet member 330 by being in contact with the first sheet member 330 from the circumferential outside.

As illustrated in FIG. 4, a second end surface 106A₂ surrounding the other end of the accommodation region 102B (opening portion) in the first disc plate 100A can support the second sheet member 332 by being in contact with the second sheet member 332 from the circumferential outside. Similarly, as illustrated in FIG. 2, a second end surface 106B₂ surrounding the other end of the accommodation region 102B (opening portion) in the second disc plate 100B can support the second sheet member 332 by being in contact with the second sheet member 332 from the circumferential outside.

Next, focusing on the accommodation region 102C. As illustrated in FIG. 4, a first end surface 108A₁ surrounding one end of the accommodation region 102C (opening portion) in the first disc plate 100A can support the first sheet member 330 by being in contact with the first sheet member 330 from the circumferential outside. Similarly, as illustrated in FIG. 2, a first end surface 108B₁ surrounding one end of the accommodation region 102C (opening portion) in the second disc plate 100B can support the first sheet member 330 by being in contact with the first sheet member 330 from the circumferential outside.

As illustrated in FIG. 4, a second end surface 108A₂ surrounding the other end of the accommodation region 102C (opening portion) in the first disc plate 100A can support the second sheet member 332 by being in contact with the second sheet member 332 from the circumferential outside. Similarly, a second end surface 108B₂ surrounding the other end of the accommodation region 102C (opening portion) in the second disc plate 100B can support the second sheet member 332 by being in contact with the second sheet member 332 from the circumferential outside.

Next, focusing on the accommodation region 102D. As illustrated in FIG. 4, a first end surface 110A₁ surrounding one end of the accommodation region 102D (opening portion) in the first disc plate 100A can support the first sheet member 330 by being in contact with the first sheet member 330 from the circumferential outside.

Similarly, as illustrated in FIG. 2, a first end surface 110B₁ surrounding one end of the accommodation region 102A (opening portion) in the second disc plate 100B can support the first sheet member 330 by being in contact with the first sheet member 330 from the circumferential outside.

As illustrated in FIG. 4, a second end surface 110A₂ surrounding the other end of the accommodation region 102D (opening portion) in the first disc plate 100A can support the second sheet member 332 by being in contact with the second sheet member 332 from the circumferential outside. Similarly, as illustrated in FIG. 2, a second end surface 110B₂ surrounding the other end of the accommodation region 102D (opening portion) in the second disc plate 100B can support the second sheet member 332 by being in contact with the second sheet member 332 from the circumferential outside.

### (2) Drawn Portion

Furthermore, the disc plate 100 can include a plurality of drawn portions that function as a stopper for restricting the relative rotation of the hub 200 with respect to the disc plate 100 by a predetermined angle or more.

Hereinafter, a configuration of the drawn portions functioning as such a stopper will be described.

For one engagement portion 208 of the hub 200, a total of two drawn portions can be disposed on both sides of the engagement portion in the circumferential direction. One of the two drawn portions can come into contact with the one engagement portion 208 to restrict rotation of the hub 200 with respect to the disc plate 100 by a predetermined angle or more in one direction (clockwise direction or counterclockwise direction). Similarly, the other of the two drawn portions can come into contact with the one engagement portion 208 to restrict rotation in the other direction (counterclockwise direction or clockwise direction).

As exemplified in FIG. 3, here, since the four engagement portions 208 (208A to 208D) are provided, a total of four drawn portions can be formed such that each one of the drawn portions is positioned between two adjacent engagement portions 208.

### (2A) First Drawn Portion

With reference to FIG. 3 in which the second disc plate 100B is omitted, a total of four first drawn portions 120 (120A, 120B, 120C, and 120D) can be formed on the first disc plate 100A. The first drawn portions 120A, 120B, 120C, and 120D can be respectively disposed adjacent to the accommodation regions 102A, 102B, 102C, and 102D.

In one example, each first drawn portion 120 can be disposed adjacent to the outer diameter side of the corresponding accommodation region 102. By adopting this configuration, as compared particularly with a configuration in which each first drawn portion 120 is disposed adjacent to the inner diameter side of the corresponding accommodation region 102, it is possible to reduce a diameter of the first disc plate 100A and, as a result, to eventually reduce a diameter of the disc plate 100.

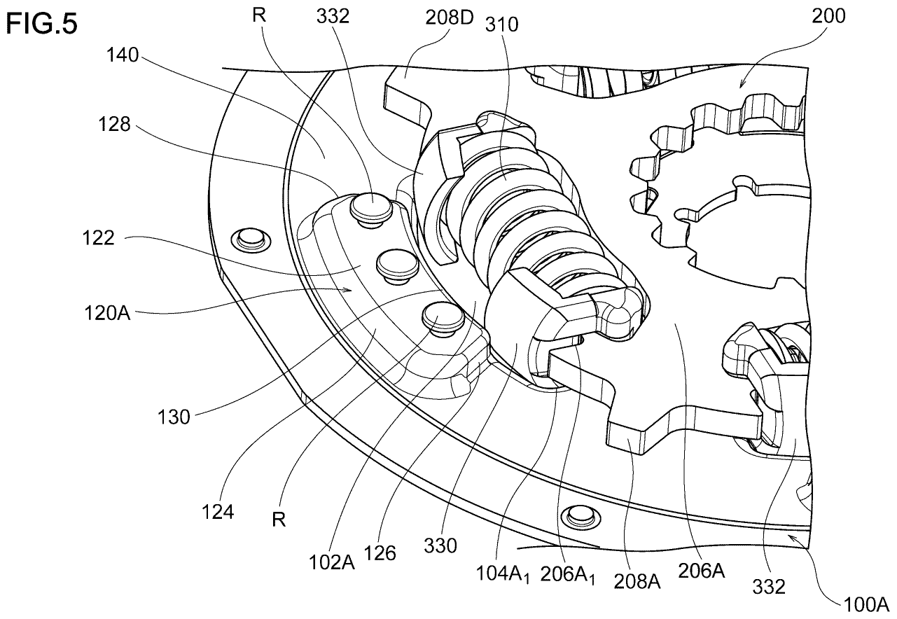

The first drawn portions 120 can have mutually the same shape; therefore, focusing here on the first drawn portion 120A, description will be given with reference to FIG. 5 in addition to FIGS. 3 and 4. FIG. 5 is an enlarged perspective view schematically illustrating a partial configuration of the damper device illustrated in FIG. 3 as viewed from a viewpoint different from that of FIG. 3.

The first drawn portion 120A can have a shape recessed from a flat first main surface 140 of the first disc plate 100A in a direction toward the second disc plate 100B (upward direction on the paper surface). Note that, the first main surface 140 can extend in a substantially annular shape on, for example, the first disc plate 100A.

Specifically, the first drawn portion 120A can include: a first fixing surface 122 extending substantially parallel to the first main surface 140; and a first wall surface 124 that surrounds a periphery of the first fixing surface 122 and continuously connects the first main surface 140 and the first fixing surface 122.

The substantially entire first fixing surface 122 can be formed as a flat surface. The first fixing surface 122 can extend in an arc shape along the circumferential direction of the first disc plate 100A. The first fixing surface 122 can be fixed to a second fixing surface 152 of a later-described second drawn portion 150A formed on the second disc plate 100B by using at least one (three in total in FIGS. 3 and 4) fastening member (for example, rivet) R. With this arrangement, the first disc plate 100A and the second disc plate 100B can be coupled to each other by at least one fastening member R.

The first wall surface 124 can be formed by, for example, a combination of a flat surface and a curved surface. A surface (first contact surface) 126, of the first wall surface 124, facing the engagement portion 208A comes into contact with the engagement portion 208A, so that the surface 126 can function as a stopper that restricts further rotation of the hub 200 in the clockwise direction with respect to the disc plate 100. Furthermore, a surface (first contact surface) 128, of the first wall surface 124, facing the engagement portion 208D comes into contact with the engagement portion 208D, so that the surface 128 can function as a stopper that restricts further rotation of the hub 200 in the counterclockwise direction with respect to the disc plate 100.

In one example, the first contact surfaces 126 and 128 can be disposed on a circumference extending with a distance between a rotation center O of the damper device 10 and the fastening member R as a radius, that is, can be disposed at a position overlapping the circumference. With such a configuration, the diameter of the first disc plate 100A can be made smaller, that is, the first disc plate 100A can be formed more compact, as compared with a configuration in which the first contact surfaces 126 and 128 are disposed at positions not on the circumference, that is, are disposed at positions not overlapping the circumference.

Furthermore, in one example, a surface (first support surface) 130, of the first wall surface 124, facing the elastic mechanism part 300 can be provided so as to surround the accommodation region 102A. With this arrangement, the first support surface 130 can support the first sheet member 330 and the second sheet member 332 from the outer side in the radial direction of the first disc plate 100A. With such a configuration, the diameter of the first disc plate 100A can be made smaller, that is, the first disc plate 100A can be formed more compact, as compared with a configuration in which the first support surface 130 is disposed at a distance from the elastic mechanism part 300.

The first drawn portions 120 each including the first drawn portion 120A described above can be formed, for example, by performing press molding on the flat first main surface 140 of the first disc plate 100A.

### (2B) Second Drawn Portion

With reference to FIGS. 1 and 2, a total of four second drawn portions 150 (150A, 150B, 150C, and 150D) can be formed on the second disc plate 100B. The second drawn portions 150A, 150B, 150C, and 150D can be respectively disposed adjacent to the accommodation regions 102A, 102B, 102C, and 102D.

In one example, each second drawn portion 150 can be disposed adjacent to the outer diameter side of the corresponding accommodation region 102. By adopting this configuration, as compared particularly with a configuration in which each second drawn portion 150 is disposed adjacent to the inner diameter side of the corresponding accommodation region 102, it is possible to reduce the diameter of the second disc plate 100B and, as a result, to eventually reduce the diameter of the disc plate 100.

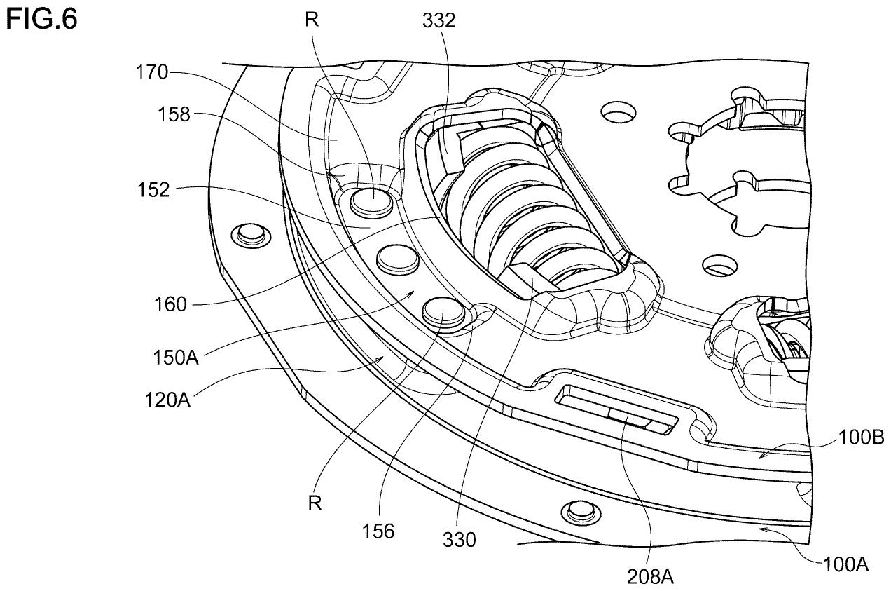

The second drawn portions 150 can have mutually the same shape; therefore, focusing here on the second drawn portion 150A, description will be given with reference to FIG. 6 in addition to FIGS. 1 and 2. FIG. 6 is an enlarged perspective view schematically illustrating a partial configuration of the damper device illustrated in FIG. 1 as viewed from a viewpoint different from that of FIG. 1.

The second drawn portion 150A can have a shape recessed from a flat second main surface 170 of the second disc plate 100B in a direction toward the corresponding first drawn portion 120 (first drawn portion 120A, here) formed on the first disc plate 100A (downward direction on the paper surface). Note that, the second main surface 170 can extend in a substantially annular shape on, for example, the second disc plate 100B.

Specifically, the second drawn portion 150A can include: a second fixing surface 152 extending substantially parallel to the second main surface 170; and a second wall surface 154 that surrounds a periphery of the first fixing surface 152 and continuously connects the second main surface 170 and the second fixing surface 152.

The substantially entire second fixing surface 152 can be formed as a flat surface. The second fixing surface 152 can extend in an arc shape along the circumferential direction of the second disc plate 100B. The second fixing surface 152 can be fixed to the first drawn portion 120A formed on the first disc plate 100A by using at least one (three in total in FIGS. 1 and 2) fastening member (for example, rivet) R.

The second wall surface 154 can be formed by, for example, a combination of a flat surface and a curved surface. A surface (second contact surface) 156, of the second wall surface 154, facing the engagement portion 208A comes into contact with the engagement portion 208A, so that the surface 156 can function as a stopper that restricts further rotation of the hub 200 in the clockwise direction with respect to the disc plate 100. Furthermore, a surface (second contact surface) 158, of the second wall surface 154, facing the engagement portion 208D comes into contact with the engagement portion 208D, so that the surface 158 can function as a stopper that restricts further rotation of the hub 200 in the counterclockwise direction with respect to the disc plate 100.

In one example, the second contact surfaces 156 and 158 can be disposed on a circumference extending with a distance between a rotation center O of the damper device 10 and the fastening member R as a radius, that is, can be disposed at a position overlapping the circumference. With such a configuration, the diameter of the second disc plate 100B can be made smaller, that is, the second disc plate 100B can be formed more compact, as compared with a configuration in which the second contact surfaces 156 and 158 are disposed at positions not on the circumference, that is, are disposed at positions not overlapping the circumference.

Furthermore, in one example, a surface (second support surface) 160, of the second wall surface 154, facing the elastic mechanism part 300 can be provided so as to surround the accommodation region 102A. With this arrangement, the second support surface 160 can support the first sheet member 330 and the second sheet member 332 from the outer side in the radial direction of the second disc plate 100B. With such a configuration, the diameter of the second disc plate 100B can be made smaller, that is, the second disc plate 100B can be formed more compact, as compared with a configuration in which the second support surface 160 is disposed at a distance from the elastic mechanism part 300.

The second drawn portions 150 each including the second drawn portion 150A described above can be formed, for example, by performing press molding on the flat second main surface 170 of the second disc plate 100B.

### 2. Operation of Damper Device 10

Next, an operation of the damper device 10 having the above configuration will be described. FIGS. 1 to 6 illustrate an initial state in which a driving force from a drive source such as an engine or a motor is not transmitted to the damper device 10, or a state in which a phase difference is not generated between the disc plate 100 and the hub 200.

Power from a drive source such as an engine or a motor can be transmitted to the disc plate 100, the second sheets 332, the elastic bodies 310, the first sheets 330, and the hub 200 in this order. When focusing on the accommodation regions 102A, the power is first transmitted from the second end surface 104A₂ (104B₂) of the disc plate 100 to the second sheet 332. The second sheet 332 transmits such power to the first sheet 330 while bending the elastic body 310. The first sheet 330 can transmit such power to the hub 200 via the notch 206A₁ of the hub 200.

Regarding the accommodation region 102B, power can be similarly transmitted from the second end surface 106A₂ (106B₂) of the disc plate 100 to the notch 206B₁ of the hub 200 via the elastic mechanism part 300 disposed in the accommodation region 102B.

Regarding the accommodation region 102C, power can be similarly transmitted from the second end surface 108A₂ (108B₂) of the disc plate 100 to the notch 206C₁ of the hub 200 via the elastic mechanism part 300 disposed in the accommodation region 102C.

Regarding the accommodation region 102D, power can be similarly transmitted from the second end surface 110A₂ (110B₂) of the disc plate 100 to the notch 206D₁ of the hub 200 via the elastic mechanism part 300 disposed in the accommodation region 102D.

On the other hand, although not illustrated in FIGS. 1 to 6, when torque transmitted to the disc plate 100 is positive (a state at the time of, for example, acceleration), the disc plate 100 can rotate counterclockwise relatively to the hub 200 on the paper surface. As a result, the second sheet 332 is pressed toward the first sheet 330 by the second end surface 104A₂ (104B₂); therefore, the second sheet 332 is separated from the notch 206D₂ of the hub 200 and comes close to the first sheet 330 against the elastic body 310. Since the hub 200 is relatively stationary, the first sheet 330 supported by the notch 206A₁ of the hub 200 does not slide. Therefore, the elastic body 310 contracts, and the first end surface 104A₁ (104B₁) of the disc plate 100 releases the support for the first sheet 330 and separates from the first sheet 330.

Thereafter, the elastic body 310 expands to return to the original shape, so that the first sheet 330 biased by the elastic body 310 presses the notch 206A₁ of the hub 200 in the counterclockwise direction on the paper surface. As a result, the hub 200 rotates counterclockwise, whereby the input shaft of the transmission (not illustrated) eventually rotates.

Such an operation is similarly performed for the elastic mechanism part 300 disposed in each of the accommodation region 102B, the accommodation region 102C, and the accommodation region 102D.

Here, considering a case where the disc plate 100 rotates counterclockwise, by a predetermined angle, on the paper surface with respect to the hub 200, that is, a case where the hub 200 rotates clockwise, by the predetermined angle, on the paper surface with respect to the disc plate 100. In this case, the first contact surfaces 126 of the first drawn portions 120 and the second contact surfaces 156 of the second drawn portions 150, which are formed on the disc plate 100, come into contact with the engagement portions 208 formed on the hub 200.

For example, the first contact surface 126 of the first drawn portion 120A and the second contact surface 156 of the second drawn portion 150A, which are provided in correspondence with the accommodation region 102A, come into contact with the engagement portion 208A formed on the hub 200. Similarly, the first contact surface 126 of the first drawn portion 120A and the second contact surface 156 of the second drawn portion 150A that are provided in correspondence with the accommodation region 102B, come into contact with the engagement portion 208B formed on the hub 200. Further similarly, the first contact surface 126 of the first drawn portion 120A and the second contact surface 156 of the second drawn portion 150A that are provided in correspondence with the accommodation region 102C (102D), come into contact with the engagement portion 208C (208D) formed on the hub 200.

As a result, the first contact surface 126 of each first drawn portion 120 and the second contact surface 156 of each second drawn portion 150 can cooperate with the corresponding engagement portion 208 formed on the hub 200 to restrict further rotation of the disc plate 100 in the counterclockwise direction on the paper surface with respect to the hub 200, that is, to restrict further rotation of the hub 200 in the clockwise direction on the paper surface with respect to the disc plate 100.

On the other hand, although not illustrated in FIGS. 1 to 6, when the torque transmitted to the disc plate 100 is negative (for example, in a state at the time of deceleration by engine brake), the disc plate 100 can rotate clockwise relatively to the hub 200 on the paper surface. As a result, the first sheet 330 is pressed toward the second sheet 332 by the first end surface 104A₁ (104B₁); therefore, the first sheet 330 is separated from the notch 206A₁ of the hub 200 and comes close to the second sheet 332 against the elastic body 310. Since the hub 200 is relatively stationary, the second sheet 332 supported by the notch 206D₂ of the hub 200 does not slide. Therefore, the elastic body 310 contracts, and the second end surface 104A₂ (104B₂) of the disc plate 100 releases the support for the second sheet 332 and separates from the second sheet 332.

Thereafter, the elastic body 310 expands to return to the original shape, so that the second sheet 332 biased by the elastic body 310 presses the notch 206D₂ of the hub 200 in the clockwise direction on the paper surface. As a result, the hub 200 rotating counterclockwise decelerates and eventually, the input shaft of the transmission (not illustrated) decelerates.

Such an operation is similarly performed for the elastic mechanism part 300 disposed in each of the accommodation region 102B, the accommodation region 102C, and the accommodation region 102D.

Here, considering a case where the disc plate 100 rotates clockwise, by a predetermined angle, on the paper surface with respect to the hub 200, that is, a case where the hub 200 rotates counterclockwise, by the predetermined angle, on the paper surface with respect to the disc plate 100. In this case, the first contact surfaces 128 of the first drawn portions 120 and the second contact surfaces 158 of the second drawn portions 150, which are formed on the disc plate 100, come into contact with the engagement portions 208 formed on the hub 200.

For example, the first contact surface 128 of the first drawn portion 120A and the second contact surface 158 of the second drawn portion 150A, which are provided in correspondence with the accommodation region 102A, come into contact with the engagement portion 208D formed on the hub 200. Similarly, the first contact surface 128 of the first drawn portion 120A and the second contact surface 158 of the second drawn portion 150A, which are provided in correspondence with the accommodation region 102B, come into contact with the engagement portion 208A formed on the hub 200. Further similarly, the first contact surface 128 of the first drawn portion 120A and the second contact surface 158 of the second drawn portion 150A, which are provided in correspondence with the accommodation region 102C (102D), come into contact with the engagement portion 208B (208C) formed on the hub 200.

As a result, the first contact surface 128 of each first drawn portion 120 and the second contact surface 158 of each second drawn portion 150 can cooperate with the corresponding engagement portion 208 formed on the hub 200 to restrict further rotation of the disc plate 100 in the clockwise direction on the paper surface with respect to the hub 200, that is, to restrict further rotation of the hub 200 in the counterclockwise direction on the paper surface with respect to the disc plate 100.

### 3. Modifications

### 3-1. Rib Provided on Drawn Portion

At least one of the drawn portions (the first drawn portions 120 and/or the second drawn portions 150) described above can include a rib extending in the circumferential direction of the disc plate 100. The drawn portion including such a rib distributes, in the circumferential direction of the disc plate 100, load or stress received from the engagement portion 208 of the hub 200 that is in contact with the drawn portion, so that it is possible to prevent a phenomenon that the rivet or rivets R are loosened and/or a phenomenon that one of the first disc plate 100A and the second disc plate 100B will become separated from the other.

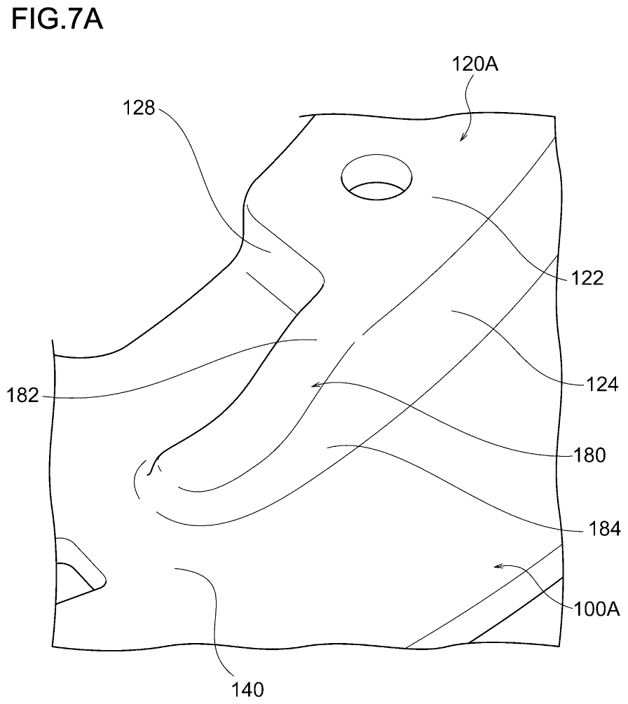

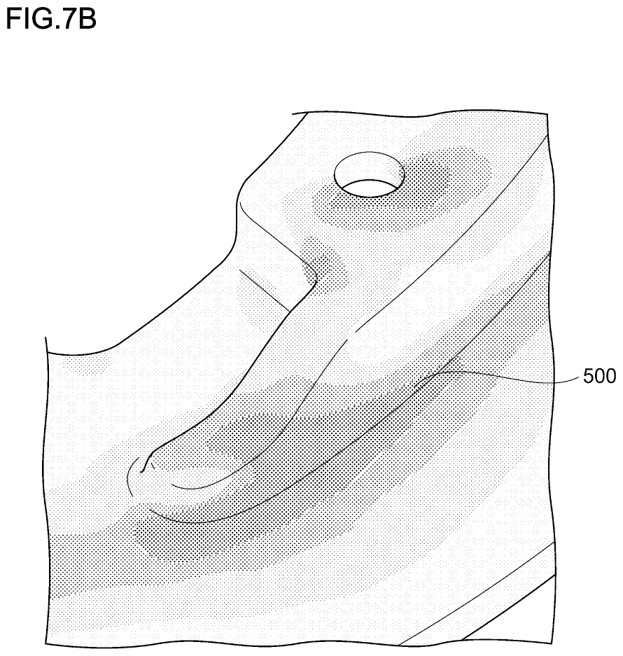

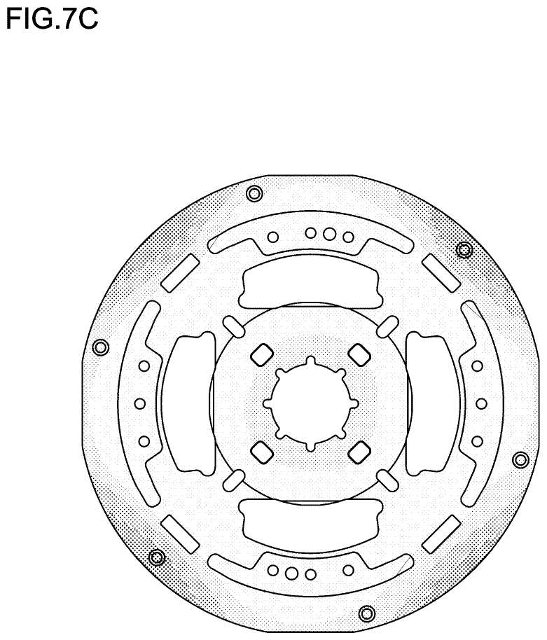

FIG. 7A is an enlarged perspective view schematically illustrating a partial configuration of the damper device illustrated in FIG. 3 in which ribs are provided on the first drawn portions 120. As illustrated in FIG. 7A, the first drawn portion 120 can include a first rib 180 that is adjacent to at least one of the two first contact surfaces 126 and 128 (the first contact surface 128 in FIG. 7A) and extends along the circumferential direction of the first disc plate 100A.

The first rib 180 can include: a basic surface 182 extending from the first fixing surface 122 of the first drawn portion 120; and a third wall surface 184 that surrounds a periphery of the basic surface 182 and continuously connects the basic surface 182 and the first main surface 140 of the first disc plate 100A.

The third wall surface 184 can be formed by, for example, a combination of a flat surface and a curved surface.

The basic surface 182 can extend in an arc shape along the circumferential direction of the first disc plate 100A. In one example, substantially the entire basic surface 182 may be formed as a flat surface. In another example, the basic surface 182 may be formed by a combination of a flat surface and a curved surface.

In a first example, substantially the entire basic surface 182 can extend substantially parallel to both the first fixing surface 122 and the first main surface 140 of the first disc plate 100A.

In a second example, as illustrated in FIG. 7A, the basic surface 182 can be inclined so as to connect the first fixing surface 122 and the first main surface 140. That is, it can be said that the basic surface 182 can include at least one point (inflection point) at which the inclination angle changes.

In the above first example, there is a possibility that the load or stress applied to the first drawn portion 120 by the engagement portion 208 of the hub 200 propagates to the root of the tip portion of the first rib 180 (the portion farthest from the first fixing surface 122) without being greatly reduced. In contrast, in the second example, since the basic surface 182 is inclined in such a direction that the basic surface 182 becomes closer to the first main surface 140 of the first disc plate 100A, the load or stress applied to the first drawn portion 120 by the engagement portion 208 of the hub 200 is easily distributed on the first main surface 140 until propagating to the root of the tip portion of the first rib 180 (the portion farthest from the first fixing surface 122). As a result, the load or stress having propagated to the root of the tip portion can be smaller than that in the first example.

The second example described above is advantageous in the following points. The vicinity of an intermediate position between one rivet R and the rivet R adjacent thereto, for example, the vicinity of an intermediate position on an arc connecting one of the first drawn portions 120 in FIG. 4 and another of the first drawn portions 120 adjacent thereto (the vicinity of an intermediate position on an arc connecting one of the second drawn portions 150 in FIG. 2 and another of the second drawn portions 150 adjacent thereto) is a position where a force for connecting and fixing the first disc plate 100A and the second disc plate 100B is weakest. In the case of the first example, just compared to the second example, there is the following possibility. A relatively large load or stress propagates to the root of the tip portion of the first rib 180 (the portion farthest from the first fixing surface 122), that is, propagates to the vicinity of the intermediate position, and contributes to the force that separates the first disc plate 100A and the second disc plate 100B from each other. In contrast, in the case of the second example, as compared with the first example, only a relatively small load or stress propagates to the root of the tip portion of the first rib 180 (the portion farthest from the first fixing surface 122), that is, propagates to the vicinity of the intermediate position. As a result, the first disc plate 100A and the second disc plate 100B can be continuously connected more firmly.

Although not shown in FIG. 7A, the first drawn portion 120 can include a first rib 180 extending adjacent to the first contact surface 126, instead of or in addition to the first rib 180 extending adjacent to the first contact surface 128. The first rib 180 extending adjacent to the first contact surface 126 can include a configuration similar to that of the above-described first rib 180 extending adjacent to the first contact surface 128.

The first drawn portion 120 including such first ribs 180 can also be formed, similarly to the first drawn portion 120 described above with reference to FIGS. 1 to 6, by performing press molding on the flat first main surface 140 of the first disc plate 100A, for example.

Furthermore, although not illustrated in FIG. 7A, the second drawn portion 150 may include a second rib adjacent to at least one of the two second contact surfaces 156 and 158 and extending along the circumferential direction of the second disc plate 100B. Such a second rib can include a configuration similar to that of the first rib 180 described above. For example, the second rib can include: a basic surface extending from the second fixing surface 152 of the second drawn portion 150; and a fourth wall surface that surrounds a periphery of the basic surface and continuously connects the basic surface and the second main surface 170 of the second disc plate 100B. The basic surface and the fourth wall surface included in the second rib can respectively include configurations similar to those of the basic surface 182 and the third wall surface 184 included in the first rib 180.

The second drawn portion 150 including such a second rib can also be formed, similarly to the second drawn portion 150 described above with reference to FIGS. 1 to 6, by performing press molding on the flat second main surface 170 of the second disc plate 100B, for example.

Next, experimental data relating to a damper device including drawn portions including such first ribs and second ribs will be briefly described.

FIG. 7B is a diagram schematically illustrating distribution of stress applied to the first drawn portion 120 and the periphery thereof when the engagement portions 208 of the hub 200 come into contact with the first drawn portions 120 in the damper device illustrated in FIG. 7A. FIG. 7C is a view schematically illustrating a displacement amount in an axial direction generated between the first disc plate 100A and the second disc plate B when the engagement portions 208 of the hub 200 come into contact with the corresponding first drawn portions and second drawn portions in the damper device including (i) the first drawn portions 120 each including, at both ends thereof, the first rib illustrated in FIG. 7A and (ii) the second drawn portions 150 (the second drawn portions 150 lacking the second ribs) illustrated in FIG. 2. Note that, here, FIG. 7C is premised on, as an example, a damper device in which each of the engagement portions 208 of the hub 200 comes into contact with both the first drawn portion and the second drawn portion. However, the damper device disclosed in the present application can adopt a configuration in which at least one of the engagement portions 208 comes into contact with at least one of the first drawn portion and the second drawn portion (that is, a configuration in which at least one of the engagement portions 208 comes into contact with only the first drawn portion, with only the second drawn portion, or with both the first drawn portion and the second drawn portion.).

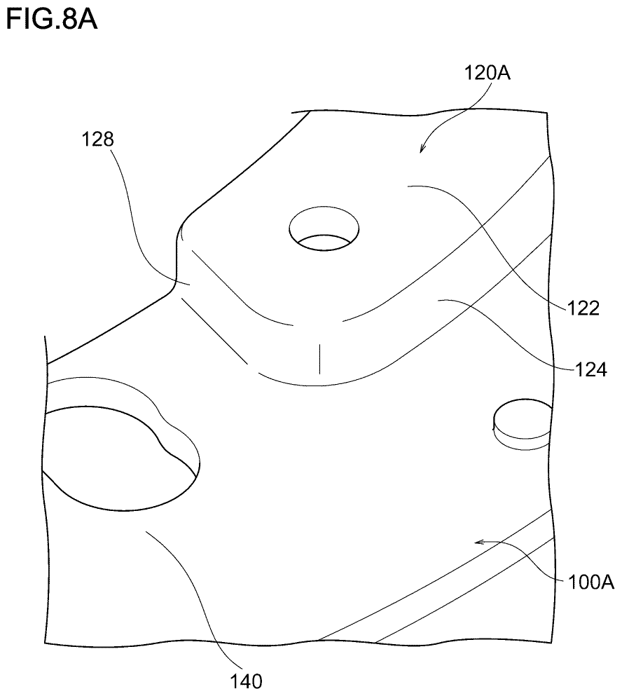

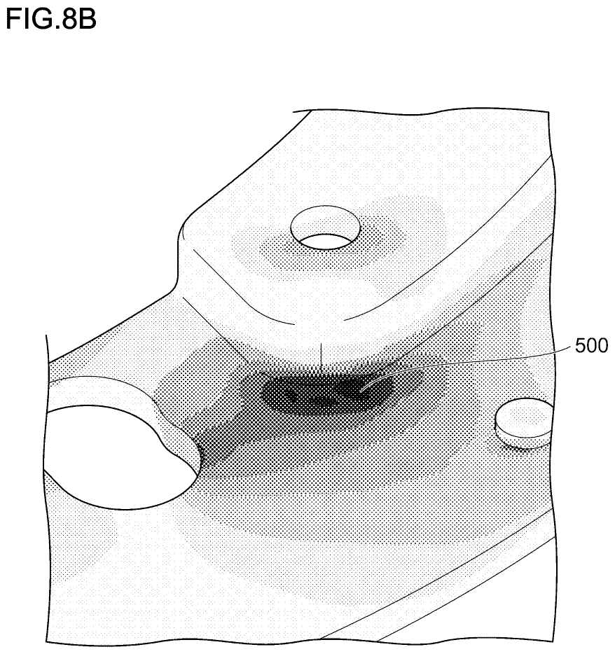

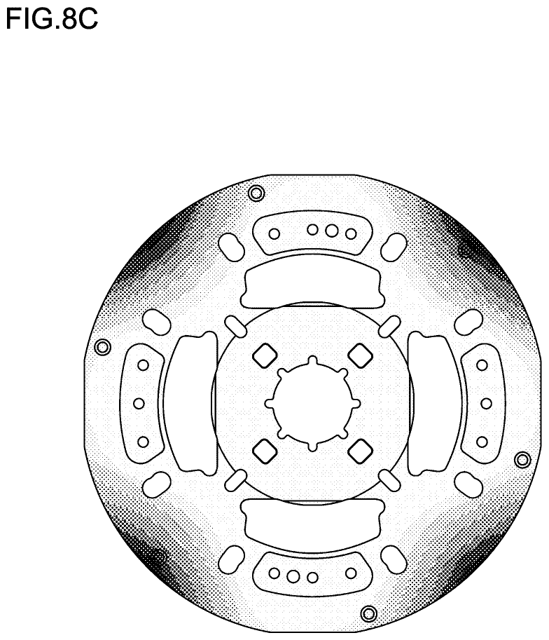

FIG. 8A is an enlarged perspective view schematically illustrating, as a comparative example with respect to the damper device illustrated in FIG. 7A, a partial configuration of the damper device illustrated in FIGS. 1 to 6. FIG. 8B is a diagram schematically illustrating distribution of stress applied to the first drawn portion 120 and the periphery thereof when the engagement portions 208 of the hub 200 come into contact with the first drawn portions 120 in the damper device illustrated in FIG. 8A. FIG. 8C is a view schematically illustrating a displacement amount in the axial direction generated between the first disc plate 100A and the second disc plate B when the engagement portions 208 of the hub 200 come into contact with the corresponding first drawn portions and second drawn portions in the damper device illustrated in FIGS. 1 to 6. Note that, here, FIG. 8C is premised on, as an example, a damper device in which each of the engagement portions 208 of the hub 200 comes into contact with both the first drawn portion and the second drawn portion. However, as described above, the damper device disclosed in the present application can adopt a configuration in which at least one of the engagement portions 208 comes into contact with at least one of the first drawn portion and the second drawn portion (that is, a configuration in which at least one of the engagement portions 208 comes into contact with only the first drawn portion, with only the second drawn portion, or with both the first drawn portion and the second drawn portion.).

When focusing on FIGS. 7B and 8B illustrating the distribution of the stress, a hatched region having a higher density indicates that the stress applied to the region is larger, and a hatched region having a lower density indicates that the stress applied to the region is smaller.

As is clear from comparison between FIGS. 7B and 8B, FIG. 8B shows that a large stress (specifically, stress of about several 100 MPa) is generated in a partial region 500 on the first wall surface 124 adjacent to the first contact surface 128. In contrast, FIG. 7B shows that such a large stress is not generated not only in the same region 500 but also in other regions. Instead, it is understood that stress is circumferentially distributed along the first rib 180. As described above, as compared with FIG. 8B, in the case of FIG. 7B, since the first ribs 180 are provided, a phenomenon is suppressed in which large stress (for example, stress of about several 100 MPa) concentrates on a specific region.

In addition, when focusing on FIGS. 7C and 8C each illustrating the displacement amount (that is, the amount of the distance by which one disc plate is separated from the other disc plate) in the axial direction generated between the first disc plate 100A and the second disc plate B, a hatched region with a higher density indicates that the displacement amount generated in the region is larger, and a hatched region with a lower density indicates that the displacement amount related to the region is smaller.

As is clear from comparison between FIG. 7C and FIG. 8C, it is understood that the displacement amount in the vicinity of an intermediate position between one rivet R and the rivet R adjacent thereto, that is, in the vicinity of an intermediate position on an arc connecting one of the first drawn portions 120 and another of the first drawn portions 120 adjacent thereto is reduced to about half in the case of FIG. 7C as compared with FIG. 8C. As described above, as compared with FIG. 8C, in the case of FIG. 7C, the first ribs 180 are provided, so that the first disc plate 100A and the second disc plate 100B are not easily separated from each other.

Note that As described above, FIG. 7C illustrates a displacement amount in the axial direction generated between the first disc plate 100A and the second disc plate 100B in the damper device including (i) the first drawn portions 120 each including, at both ends thereof, the first rib illustrated in FIG. 7A and (ii) the second drawn portions 150 (that is, the second drawn portions 150 lacking the second ribs) illustrated in FIG. 2. However, also in a damper device including (i) the first drawn portions 120 lacking the first ribs and (ii) the second drawn portions 150 each including, at both ends thereof, the second rib having a configuration similar to that of the first rib illustrated in FIG. 7A, it is possible to obtain an effect similar to that illustrated in FIG. 7C. Furthermore, also in a damper device including (i) the first drawn portions 120 each including, at both end thereof, the first rib illustrated in FIG. 7A and (ii) the second drawn portions 150 each including, at both ends thereof, the second rib having a configuration similar to that of the first rib illustrated in FIG. 7A, it is possible to obtain an effect equal to or higher than that illustrated in FIG. 7C.

### 3-2. Inclination Angle of First Contact Surface and Second Contact Surface of Drawn Portion

With reference to FIG. 4, in a first example, each first contact surface of the first contact surfaces 126 and 128 of each first drawn portion 120 may be formed to extend parallel to a line connecting the each first contact surface and the rotation center O of the damper device 10. In this case, the engagement portion 208 of the hub 200 can be formed so as to extend parallel to the first contact surface as described above (, so that the engagement portion 208 comes into surface contact with the first contact surface). This configuration can be similarly applied to each of the second contact surfaces 156 and 158 of the second drawn portions 150 illustrated in FIG. 6 and the like.

With reference to FIG. 4, in a second example, each first contact surface of the first contact surfaces 126 and 128 of each first drawn portion 120 may be formed to be inclined at an arbitrary angle with respect to an imaginary line connecting the each first contact surface and the rotation center O of the damper device 10. With this arrangement, the stress generated at the root portion of the engagement portion 208, of the hub 200, having come into contact with the first contact surface is reduced, it is possible to suppress a phenomenon that the engagement portion 208 is damaged at its root portion.

Also in this case, the engagement portion 208 of the hub 200 can be formed so as to extend parallel to the first contact surface as described above (, so that the engagement portion 208 comes into surface contact with the first contact surface). This configuration can be similarly applied to each of the second contact surfaces 156 and 158 of the second drawn portions 150 illustrated in FIG. 6 and the like.

### 3-3. Others

In the various examples described above, descriptions have been given to the following case. At least one first drawn portion 120 is provided on the first disc plate 100A; and a second drawn portion 150 is provided on the second disc plate 100B, at a position corresponding to each first drawn portion 120.

However, in another example, it is also possible to adopt the following configuration. At least one first drawn portion 120 is provided only on the first disc plate 100A, and a second drawn portion 150 is not provided on the second disc plate 100B. In this case, the first fixing portion 122 of the first drawn portion 120 can be fixed to the second main surface 170 of the second disc plate 100B with a fastening member (for example, a rivet R).

In still another example, it is also possible to adopt the following configuration. At least one second drawn portion 150 is provided only on the second disc plate 100B, and a first drawn portion 120 is not provided on the first disc plate 100A. In this case, the second fixing portion 152 of the second drawn portions 150 can be fixed to the first main surface 140 of the first disc plate 100A with a fastening member (for example, a rivet R).

Still furthermore, on the premise that at least one first drawn portion 120 is provided on the first disc plate 100A and that a second drawn portion 150 is provided on the second disc plate 100B, at a position corresponding to each first drawn portion 120, the damper device disclosed in the present application can also adopt the following configuration. A stopper is provided on at least one of the first drawn portion 120 and the second drawn portion 150 (that is, only the first drawn portion 120, only the second drawn portion 150, or both the first drawn portion 120 and the second drawn portion 150).

Here, “providing a stopper on the first drawn portion 120” means that at least one first drawn portion 120 is provided with first contact surfaces 126 and 128 each of which faces the engagement portion 208 of the hub 200 and comes into contact with the engagement portion 208. Here, “providing a stopper on the second drawn portion 150” means that at least one second drawn portion 150 is provided with second contact surfaces 156 and 158 each of which faces the engagement portion 208 of the hub 200 and comes into contact with the engagement portion 208.

Furthermore, in the embodiments described above, the case where the hub 200 has the shape illustrated in FIG. 4 has been described. However, the technique disclosed in the present application can also be applied to a case of using a hub having an arbitrary shape as long as the hub includes the following basic configuration. The hub rotates about a rotation axis relatively with respect to a disc plate while expanding or contracting an elastic mechanism part disposed, along the circumferential direction, between the hub and the disc plate and the like, and the hub includes an engagement portion protruding radially outward at an outer peripheral edge thereof.

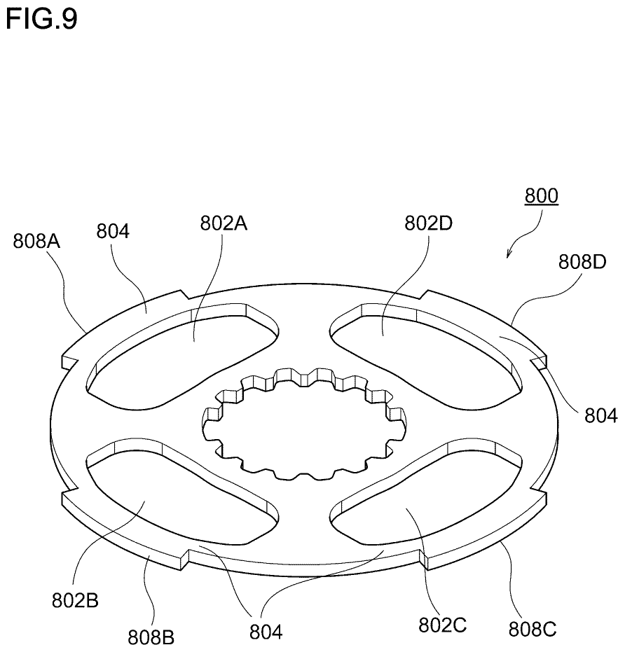

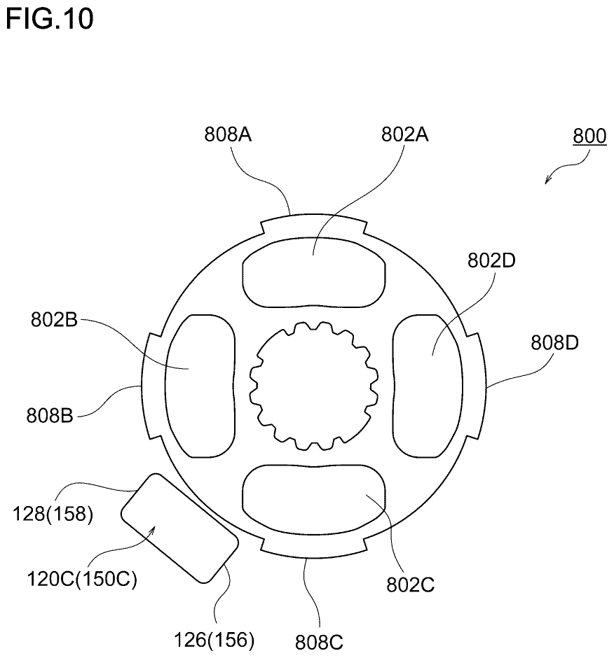

Another example of such a hub is illustrated in FIGS. 9 and 10. FIG. 9 is a perspective view schematically illustrating a configuration of another hub used in the damper device illustrated in FIG. 1. FIG. 10 is a top view schematically illustrating the configuration of the hub illustrated in FIG. 9.

Hereinafter, the configuration of the hub 200Y illustrated in FIGS. 9 and 10 will be described focusing only on differences from the configuration of the above-described hub 200.

With reference to FIGS. 9 and 10, the hub 800 can include four opening portions 802 (opening portions 802A, 802B, 802C, and 802D), respectively, in correspondence with the accommodation regions 102A, 102B, 102C, and 102D formed in the disc plate 100. Each opening portion 802 accommodates the above-described set of elastic mechanism part 300.

The radially outer side of each opening portion 802 is not formed as an open end as in the hub 200 illustrated in FIG. 3. An outer peripheral portion 804 connected along the circumferential direction extends on the radially outer side of each opening portion 802.

Furthermore, the hub 800 can include, on the outer peripheral portions 804, engagement portions 808 (engagement portions 808A, 808B, 808C, and 808D) each extending radially outward of one of the opening portions 802. Each engagement portion 808 protrudes radially outward.

Note that the hub 800 illustrated in FIGS. 9 and 10 is sometimes referred to as a “bridge type” hub.

Referring to FIG. 10, for example, the first contact surfaces 126 and 128 (see FIG. 4) of the first drawn portion 120C and/or the second contact surfaces 156 and 158 (see FIG. 2) of the second drawn portion 150C can be positioned on an arc connecting the engagement portion 808B and the engagement portion 808C. With this arrangement, when the hub 800 rotates counterclockwise on the paper surface with respect to the disc plate 100 by a predetermined angle, the engagement portion 808B can come into contact with the first contact surface 128 and/or the second contact surface 158. Conversely, when the hub 800 rotates clockwise on the paper surface with respect to the disc plate 100 by a predetermined angle, the engagement portion 808C can come into contact with the first contact surface 126 and/or the second contact surface 156. Note that, in FIG. 10, the first drawn portion 120C and/or the second drawn portion 150C is drawn to have a rectangular shape for the sake of simplicity, but actually includes the configuration described above, with reference to FIG. 4 and the like.

Although not illustrated in FIG. 10, the first contact surfaces 126 and 128 (see FIG. 4) of the first drawn portion 120D and/or the second contact surfaces 156 and 158 (see FIG. 2) of the second drawn portion 150D can be positioned on an arc connecting the engagement portion 808C and the engagement portion 808D. Similarly, the first contact surfaces 126 and 128 (see FIG. 4) of the first drawn portion 120A and/or the second contact surfaces 156 and 158 (see FIG. 2) of the second drawn portion 150A can be positioned on an arc connecting the engagement portion 808D and the engagement portion 808A. Further similarly, the first contact surfaces 126 and 128 (see FIG. 4) of the first drawn portion 120B and/or the second contact surfaces 156 and 158 (see FIG. 2) of the second drawn portion 150B can be positioned on an arc connecting the engagement portion 808A and the engagement portion 808B.

In a case where such a hub 800 is adopted, it is possible to improve, as compared with a case where the above-described hub 200 is adopted, a degree of freedom in disposition of the elastic mechanism part 300 and the stoppers (the first contact surfaces 126 and 128 of the first drawn portions 120 and/or the second contact surfaces 156 and 158 of the second drawn portions 150).

In addition, as will be easily understood by those skilled in the art having the benefit of the present disclosure, the various examples described above may be appropriately combined with each other and used in various patterns as long as no contradiction arises.

As described above, according to the technique disclosed in the present application, on at least one plate of a first disc plate and a second disc plate that constitute a disc plate (first rotation body), there is formed at least one drawn portion that has a shape recessed toward the other plate such that the at least one drawn portion comes into contact with an engagement portion protruding radially outward on an outer peripheral edge of a hub (second rotation body). The drawn portion comes into contact with the engagement portion of the hub and functions as a “stopper” that prevents the hub from rotating with respect to the disc plate by a predetermined angle or more.

A contact surface that is on the drawn portion and comes into contact with the engagement portion is formed not of a cross section of the plate but of a wall surface of the plate (, so that a contact area between the contact surface and the engagement portion is made larger); therefore, it is possible to reduce a value of a stress per unit area (surface pressure) received from the engagement portion. As a result, strength of the contact surface of the drawn portion can be maintained higher.

Furthermore, the contact surface of the drawn portion is not formed of a soft material such as a bendable rivet but is formed of the disc plate itself, it is possible to reduce the possibility of deformation caused by coming into contact with the engagement portion.

Still furthermore, a fastening member (rivet or the like) for coupling the first disc plate and the second disc plate that constitute the disc plate does not directly come into contact with the engagement portion. Therefore, it is possible to avoid a phenomenon that the fastening member is loosened or deformed by coming into contact with the engagement portion.

As described above, the technique disclosed in the present application makes it possible to provide a damper device including a stopper having improved performance.

### 4. Various Aspects

A damper device according to a first aspect can adopt the following configuration. “A configuration including: a first rotation body, the first rotation body including: a first plate to which power is transmitted from a flywheel and that rotates about a rotation axis; a second plate that is disposed to face the first plate at a distance from the first plate and rotates integrally with the first plate about the rotation axis; and a second rotation body that rotates relative to the first rotation body about the rotation axis while expanding or contracting an elastic mechanism part disposed along a circumferential direction between the second rotation body and the first rotation body, the second rotation body including an engagement portion protruding radially outward at an outer peripheral edge of the second rotation body. The first plate includes a first drawn portion recessed in a direction from a first main surface of the first plate toward the second plate, and the second plate includes a second drawn portion that is provided to face the first drawn portion, is recessed in a direction from a second main surface of the second plate toward the first drawn portion, and is fixed to the first drawn portion by using a fastening member, and the first drawn portion and/or the second drawn portion comes into contact with the engagement portion of the second rotation body in a state of relatively rotating with respect to the first rotation body, and restrict further rotation of the second rotation body in a direction in which the elastic mechanism part is contracted.”

A damper device according to a second aspect can adopt, in the above first aspect, the following configuration. “The first drawn portion includes: a first fixing surface that extends substantially parallel to the first main surface of the first plate and is fixed to the second drawn portion by using the fastening member; and a first wall surface that surrounds the first fixing surface and connects the first main surface and the first fixing surface, and a first contact surface that is part of the first wall surface and faces the engagement portion comes into contact with the engagement portion to restrict rotation of the second rotation body in a direction in which the elastic mechanism part is contracted.”

A damper device according to a third aspect can adopt, in the above first aspect, the following configuration. “The second drawn portion includes: a second fixing surface that extends substantially parallel to the second main surface of the second plate and is fixed to the first drawn portion with the fastening member; and a second wall surface that surrounds the second fixing surface and connects the second main surface and the second fixing surface, and a second contact surface that is part of the second wall surface and faces the engagement portion comes into contact with the engagement portion to restrict rotation of the second rotation body in a direction in which the elastic mechanism part is contracted.”

A damper device according to a fourth aspect can adopt, in the above second aspect or third aspect, the following configuration. “When premised on the above second aspect, the first contact surface is disposed on a circumference extending with a distance between a rotation center of the damper device and the fastening member as a radius, and when premised on the third aspect, the second contact surface is disposed on a circumference extending with a distance between the rotation center of the damper device and the fastening member as a radius.”

A damper device according to a fifth aspect can adopt, in the above second aspect or third aspect, the following configuration. “The elastic mechanism part includes: an elastic member; a first sheet member provided in contact with a first end of the elastic member; and a second sheet member provided in contact with a second end of the elastic member. When premised on the above second aspect, a first support surface that is part of the first wall surface and faces the elastic member supports the first sheet member and the second sheet member, and when premised on the above third aspect, a second support surface that is part of the second wall surface and faces the elastic mechanism part supports the first sheet member and the second sheet member.”

A damper device according to a sixth aspect can adopt, in the above second aspect or third aspect, the following configuration. “When premised on the second aspect, the first drawn portion includes a first rib that is adjacent to the first contact surface and extends along a circumferential direction of the first plate, and when premised on the third aspect, the second drawn portion includes a second rib that is adjacent to the second contact surface and extends along a circumferential direction of the second plate.”

A damper device according to a seventh aspect can adopt, in the above sixth aspect, the following configuration. “The first rib is inclined so as to connect the first fixing surface and the first main surface of the first plate, and the second rib is inclined so as to connect the second fixing surface and the second main surface of the second plate.”

### REFERENCE SIGNS LIST

O: Rotation axis (Rotation center), R: Fastening member (rivet and the like), 10: Damper device, 100: Disc plate (First rotation body), 100A: First disc plate (First plate), 120, 120A, 120B, 120C, 120D: First drawn portion, 122: First fixing surface, 124: First wall surface, 126, 128: First contact surface, 130: First support surface, 140: First main surface, 100B: Second disc plate (Second plate), 150, 150A, 150B, 150C, 150D: Second drawn portion, 152: Second fixing surface, 154: Second wall surface, 156, 158: Second contact surface, 160: Second support surface, 170: Second main surface, 180: First rib, 200: Hub (Second rotation body), 208, 208A, 208B, 208C, 208D: Engagement portion, 300: Elastic mechanism part, 310: Elastic body (Elastic member), 330: First sheet member, and 332: Second sheet member

1-7. (canceled)

8. A damper device comprising:
a first rotation body, the first rotation body including:
a first plate to which power is transmitted from a flywheel and that rotates about a rotation axis;
a second plate that is disposed to face the first plate at a distance from the first plate and rotates integrally with the first plate about the rotation axis; and
a second rotation body that rotates relative to the first rotation body about the rotation axis while expanding or contracting an elastic mechanism part disposed along a circumferential direction between the second rotation body and the first rotation body, the second rotation body including an engagement portion protruding radially outward at an outer peripheral edge of the second rotation body,
wherein the first plate includes a first drawn portion recessed in a direction from a first main surface of the first plate toward the second plate, and
the second plate includes a second drawn portion that is provided to face the first drawn portion, is recessed in a direction from a second main surface of the second plate toward the first drawn portion, and is fixed to the first drawn portion by using a fastening member, and
the first drawn portion and/or the second drawn portion comes into contact with the engagement portion of the second rotation body in a state of relatively rotating with respect to the first rotation body, and restricts further rotation of the second rotation body in a direction in which the elastic mechanism part is contracted.

9. The damper device according to claim 8, wherein the first drawn portion includes:
a first fixing surface that extends substantially parallel to the first main surface of the first plate and is fixed to the second drawn portion by using the fastening member; and
a first wall surface that surrounds the first fixing surface and connects the first main surface and the first fixing surface, and
a first contact surface that is part of the first wall surface and faces the engagement portion comes into contact with the engagement portion to restrict rotation of the second rotation body in a direction in which the elastic mechanism part is contracted.

10. The damper device according to claim 8, wherein the second drawn portion includes:
a second fixing surface that extends substantially parallel to the second main surface of the second plate and is fixed to the first drawn portion with the fastening member; and
a second wall surface that surrounds the second fixing surface and connects the second main surface and the second fixing surface, and
a second contact surface that is part of the second wall surface and faces the engagement portion comes into contact with the engagement portion to restrict rotation of the second rotation body in a direction in which the elastic mechanism part is contracted.

11. The damper device according to claim 9, wherein the first contact surface is disposed on a circumference extending with a distance between a rotation center of the damper device and the fastening member as a radius.

12. The damper device according to claim 10, wherein the second contact surface is disposed on a circumference extending with a distance between the rotation center of the damper device and the fastening member as a radius.

13. The damper device according to claim 9, wherein the elastic mechanism part includes:
an elastic member;
a first sheet member provided in contact with a first end of the elastic member; and
a second sheet member provided in contact with a second end of the elastic member, and
a first support surface that is part of the first wall surface and faces the elastic member supports the first sheet member and the second sheet member.

14. The damper device according to claim 10, wherein the elastic mechanism part includes:
an elastic member;
a first sheet member provided in contact with a first end of the elastic member; and
a second sheet member provided in contact with a second end of the elastic member, and
a second support surface that is part of the second wall surface and faces the elastic mechanism part supports the first sheet member and the second sheet member.

15. The damper device according to claim 9, wherein the first drawn portion includes a first rib that is adjacent to the first contact surface and extends along a circumferential direction of the first plate.

16. The damper device according to claim 10, wherein the second drawn portion includes a second rib that is adjacent to the second contact surface and extends along a circumferential direction of the second plate.

17. The damper device according to claim 13, wherein the first rib is inclined so as to connect the first fixing surface and the first main surface of the first plate, and
the second rib is inclined so as to connect the second fixing surface and the second main surface of the second plate.
